(19) United States
(12) Patent Application Publication
(10) Pub. No.: US 2002/0124172 A1
(43) Pub. Date: Sep. 5, 2002

(54) Method and apparatus for signing and validating web pages

(76) Inventor: Brian Manahan, Aliso Viejo, CA (US)

Correspondence Address: IRELL & MANELLA LLP, 840 NEWPORT CENTER DRIVE, SUITE 400, NEWPORT BEACH, CA, 92660, US

(21) Appl. No.: 09/800,346

(22) Filed: Mar. 5, 2001

(51) Int. Cl. H04L 9/00

(52) U.S. Cl. 713/176

(57) ABSTRACT

A method and apparatus for signing and validating web pages. In one embodiment, a web page that includes a trigger is digitally signed with a private key to provide a digital signature. The web page, digital signature, and a digital certificate are transmitted from a first computer system to a second computer system. On the second computer system, in response to the trigger, the digital signature is automatically verified using a public key corresponding to the private key. An object may optionally be transmitted with the web page from the first computer system to the second computer system. The object includes a plug-in, code, etc. The trigger includes a flag, variable, one or more lines of code, or subroutine that may be embedded or incorporated in, or appended to the web page, or a header of the web page.

### BACKGROUND OF THE INVENTION

1. Field of the Invention

The present invention relates generally to security, and specifically, to a method and apparatus for signing and validating web pages.

2. Description of the Related Art

The Internet is now commonplace in most of our everyday lives, providing an avenue for, among other things, retrieving a wealth of information, purchasing goods and services, and communicating. Almost any information conceivable is now available on the World Wide Web. Common transactions on the Internet include purchasing goods and services (e.g., by providing credit card information) to performing personal banking.

Unfortunately, the Internet also brings a number of problems. That is, a major concern of the Internet is security and integrity of information. A number of security techniques have been developed to combat the interception of information by a hacker. For example, the Secure Sockets Layer (SSL) protocol developed by Netscape™ is used for transmitting private documents over the Internet. SSL is a good technology for preventing a hacker from altering the content of a website with a man-in-the-middle attack. In a man-in-the-middle attack a hacker-invoked program intercepts SSL protocol communications between a client and a server. The program intercepts the legitimate keys that are passed between the client and server during the SSL protocol handshaking stage, and substitutes its own keys. Consequently, the hacker program appears to the client that it is the server and appears to the server that it is the client.

Unfortunately, SSL provides no protection against information being altered on the server. Once the information is altered on the server, such altered information is undetectable by SSL or other similar protocols.

Another major concern with the Internet is the validity and authentication of web pages. The Internet provides a great avenue for obtaining information, but it is nearly impossible to attach any validity and authorship to the information obtained. Web pages are often the sole source of information for purposes ranging from school reports to court documents. Since Internet information/content changes so fast, there is no way to determine if the content saved or printed ever came from the web page it is claimed to have come from, and/or the author or source of the content.

What is desired is an apparatus and method that generally overcomes the drawbacks mentioned above.

### BRIEF SUMMARY OF THE INVENTION

The present invention comprises a method and apparatus for signing and validating web pages. In one embodiment, a web page that includes a trigger is digitally signed with a private key to provide a digital signature. The web page, digital signature, and a digital certificate are transmitted from a first computer system to a second computer system. On the second computer system, in response to the trigger, the digital signature is automatically verified using a public key corresponding to the private key. An object may optionally be transmitted with the web page from the first computer system to the second computer system. The object includes a plug-in, code, etc. The trigger includes a flag, variable, one or more lines of code, or subroutine that may be embedded or incorporated in, or appended to the web page, or a header of the web page.

Other embodiments are described and claimed herein.

### BRIEF DESCRIPTION OF THE DRAWINGS

FIG. 1 illustrates a block diagram of an exemplary system for singing, disseminating, validating, and authenticating web pages, according to one embodiment of the present invention.

FIG. 2 shows an exemplary process for creating a signed web page, according to one embodiment of the present invention.

FIG. 3 illustrates an exemplary process on a recipient computer system for verifying and authenticating a web page, according to one embodiment of the present invention.

FIG. 4 shows an exemplary process for periodically checking the validity of web pages, and reporting any invalid pages, according to one embodiment of the present invention.

FIG. 5 shows an exemplary signing and validating process, according to another embodiment of the present invention.

FIG. 6 illustrates a block diagram of a computer system, according to one embodiment of the present invention.

### DETAILED DESCRIPTION

The present invention comprises a method and apparatus for signing and validating web pages. In one embodiment, a web page that includes a trigger is digitally signed with a private key to provide a digital signature. The web page, digital signature, and a digital certificate are transmitted from a first computer system to a second computer system. On the second computer system, in response to the trigger, the digital signature is automatically verified using a public key corresponding to the private key. An object may optionally be transmitted with the web page from the first computer system to the second computer system. The object includes a plug-in, code, etc. The trigger includes a flag, variable, one or more lines of code, or subroutine that may be embedded or incorporated in, or appended to the web page, or a header (e.g., HTTP header) of the web page.

As discussed herein, a “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. “Media” or “media stream” is generally defined as a stream of digital bits that represent data, audio, video, facsimile, multimedia, and combinations thereof. A “communication link” is generally defined as any medium over which information may be transferred such as, for example, electrical wire, optical fiber, cable, plain old telephone system (POTS) lines, wireless (e.g., satellite, radio frequency “RF”, infrared, etc.), portable media (e.g., floppy disk), and the like. Information is defined in general as media and/or signaling commands.

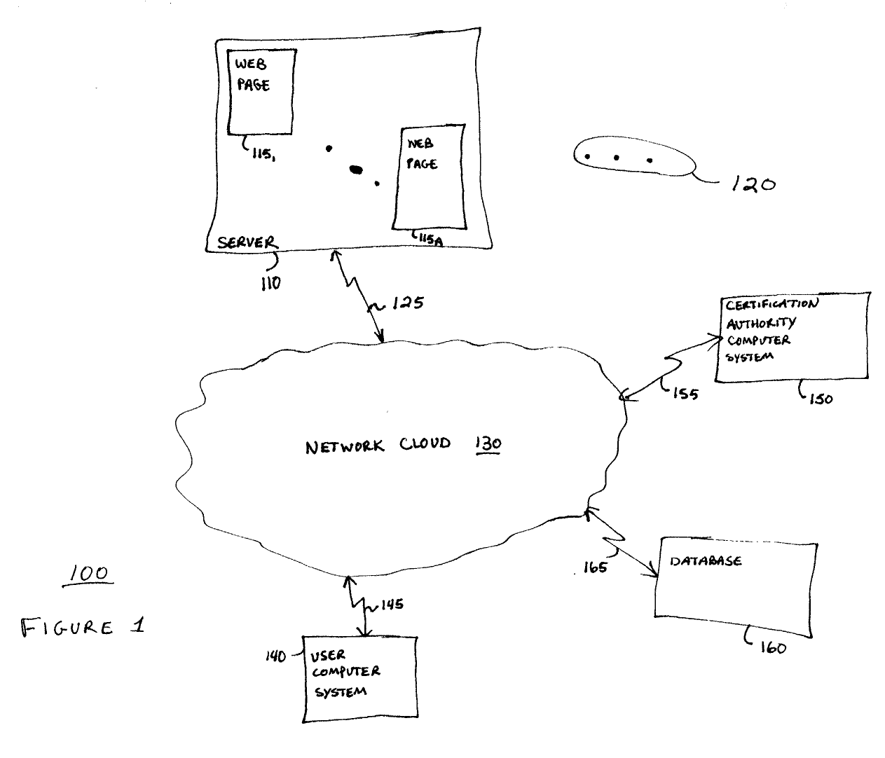

FIG. 1 illustrates a block diagram of an exemplary system 100 for singing, disseminating, validating, and authenticating web pages, according to one embodiment of the present invention. For illustration purposes, the system 100 will be described with respect to public key infrastructure (PKI) certificates. However, it is to be understood that the present invention may be used with all types of digital certificates and digital certificate protocols, whether a standard or not, such as, for example, the CCITT X.509 standard certificate.

Referring to FIG. 1, the computer system 100 includes a server computer system 110, which includes at least a processor, memory, communication circuitry, one or more web pages 115₁-115_{A} (where “A” is a positive whole number) stored in memory, and software programs running thereon. The server computer system 110 is coupled to a network cloud 130 via communication link 125. In one embodiment, the network cloud 130 includes a local area network (LAN), wide area network (WAN), Internet, other global computer network, Intranet, one or more direct link connections, and/or combinations thereof. For sake of clarity and to provide a nonrestrictive example, the network cloud 130 will also be referred to herein as the Internet.

The server computer system 110 hosts web pages 115₁-115_{A}, which may be created on the server computer system 110, or may be loaded thereon. The server computer system 110 may represent any type of portal on the Internet such as a manufacturer, retailer, news organization, educational institution, etc. The server computer system 110 may sign each of the web pages 115₁-115_{A}, according to the teachings of the present invention. The web pages 115₁-115_{A} may be transmitted to users upon request or otherwise. A web page is defined broadly as any information downloaded or otherwise obtained from a server. Such information is limitless and may include, but is not limited or restricted to, publications, articles, forms, advertisements, stock quotes, news, bank statements, etc. The web page may be stored (e.g., on a hard disk) as a file on the server computer system.

For sake of illustration and clarity, FIG. 1 only shows a single server computer system 110 coupled to the network cloud 130. Practically speaking, a plurality of such server computer systems are coupled to the network cloud 130, as represented by numeral 120. Moreover, the server computer system 110 may represent a plurality of computer systems coupled together by a network or some other means. That is, an entity may have, and often does, a plurality of servers, which collectively provide the Internet portal.

The system 100 further includes a plurality of user computer systems, only one of which is shown, as represented by numeral 140. The user computer system 140 is coupled to the network cloud 130 via a communication link 145. The user computer system 140 includes a processor, memory, communication circuitry, etc. and software running thereon for, among other things, downloading signed and unsigned web pages and web page content over the network cloud 130, verifying and authenticating digitally signed web pages using certificates (e.g., PKI certificates), and signing web pages and providing the same to recipients, according to embodiments of the present invention.

The system 100 also includes a computer system 150 of a certification authority that is coupled to the network cloud 130 via communication link 155. The certification authority computer system 150 creates and issues digital certificates or components thereof for use with the present invention. In one embodiment, the block 150 represents more than one computer system coupled together via a local network (not shown), operated by the certification authority. The certification authority is a trusted third party that can confirm the identity of an entity that digitally signs web pages. The computer system 150 may include software for running an Internet portal that hosts web pages, allowing subscribers to easily obtain digital certificates or components thereof online.

The system 100 further includes an optional central database 160 is operated by a computer system (not labeled or shown). The database 160 (as part of the computer system) is coupled to the network cloud 130 via communication link 165. In one embodiment, the database stores a list of authorized/valid digital certificates, and optionally a list of invalid certificates. The database 160 may be located at and/or controlled by the certification authority. The database 160 may be integrated as part of the computer system 150.

Continuing to refer to FIG. 1, one or more of the web pages 115₁-115_{A} on the server computer system 110 may include a “trigger” and/or one or more of the same or different web pages 115₁-115_{A} may be digitally signed. A trigger is one or more instructions or lines of code, or a flag that is embedded in or appended to the web page, or to a header (e.g., a Hypertext Transfer Protocol, “HTTP” header) of the web page. The purpose of the trigger is to invoke a software program or plug-in of such software program on a recipient computer system to verify and authenticate the web page.

The signed web page, digital signature, and digital certificate may be downloaded (e.g., upon request by a user) to the user computer system 140. The software running on the user computer system 140 may include a browser software program such as the Internet Explorer™ or the Netscape Navigator™, or a “plug-in” for such software program. It is to be noted that the software program may be any kind of program that can interpret and display web pages on the user computer system 140. If the digital signature and digital certificate are included with or appended to the web page, then the software program will verify and authenticate the web page. If the web page is valid, the software program can display an icon or other indicator on a display screen indicating that the web page is valid and authenticated. If the digital signature of the web page does not match up, then the software program may display a warning on the display screen and/or prevent the web page from being displayed. The software on user computer system 140 may validate the digital certificate of the entity providing the web page with the certificate stored in the database 160.

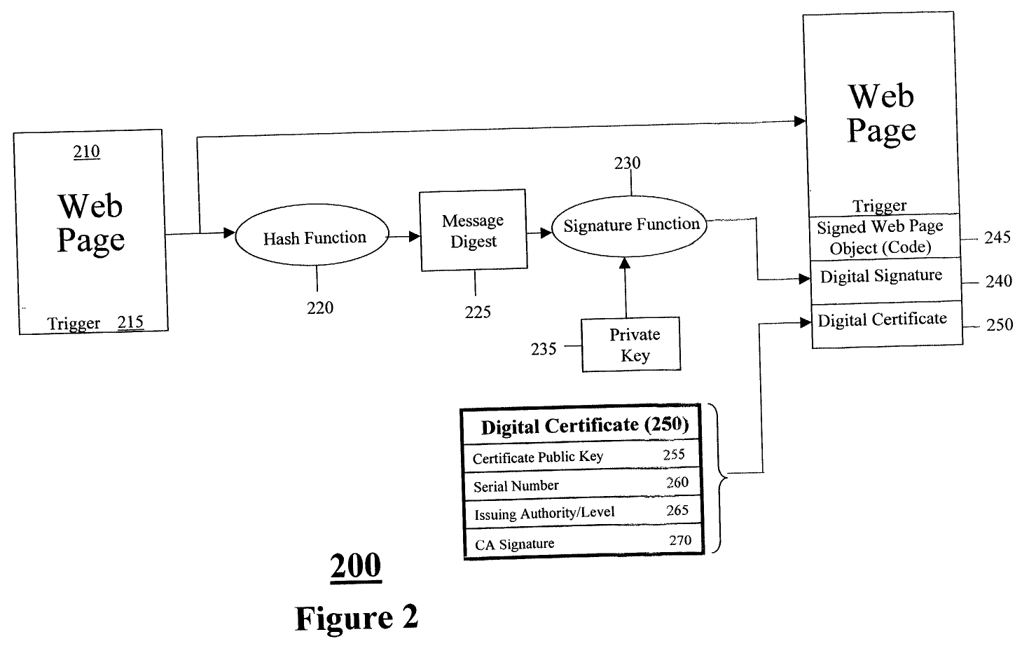

FIG. 2 shows an exemplary process 200 for creating a signed web page, 10 according to one embodiment of the present invention. Referring to FIG. 2, a web page 210 is stored on a server computer system. A trigger 215 is embedded in or appended to the web page 210, or a header of the web page 210. The trigger 215 may be embedded during creation of the web page 210 or thereafter. Alternatively, the trigger may be embedded in or appended to the web page on the fly. That is, when the web page is to be downloaded.

To digitally sign a web page, a digital certificate and a corresponding private signing key are obtained. In one embodiment, the digital certificate and the private signing key are obtained from a certification authority. An exemplary digital certificate is shown in FIG. 2 as numeral 250. The digital certificate 250 includes a certificate public key 255, serial number 260, issuing authority/level 265, and CA signature 270. The certificate public key 255 is a traditional public key used to validate a web page that has been digitally signed with a corresponding private key. The serial number 260 is a unique serial number assigned to the digital certificate 250. The issuing authority/level 265 identifies the name and other related information of the certification authority. The CA signature 270 includes the certification authority digital signature. The digital certificate 250 may include other components that have not been shown. Such components include, for example, a validity stamp specifying the period of validity of the digital certificate, a version number, etc. The private key is represented by numeral 235 and corresponds to the certificate public key 255. It is to be noted that the private key 235 may be implemented on a smart card.

In one embodiment, digitally signing a web page 210 commences with the web page 210 being applied to a hash function 220. In one embodiment, the hash function 220 performs a mathematical algorithm on the web page 210, and outputs a message digest 225, which is a string of bits. In essence, the hash function 220 takes a variable input (e.g., web page 210), and generates an output that is generally smaller than the input. The message digest 225 is then applied to a signature function 230.

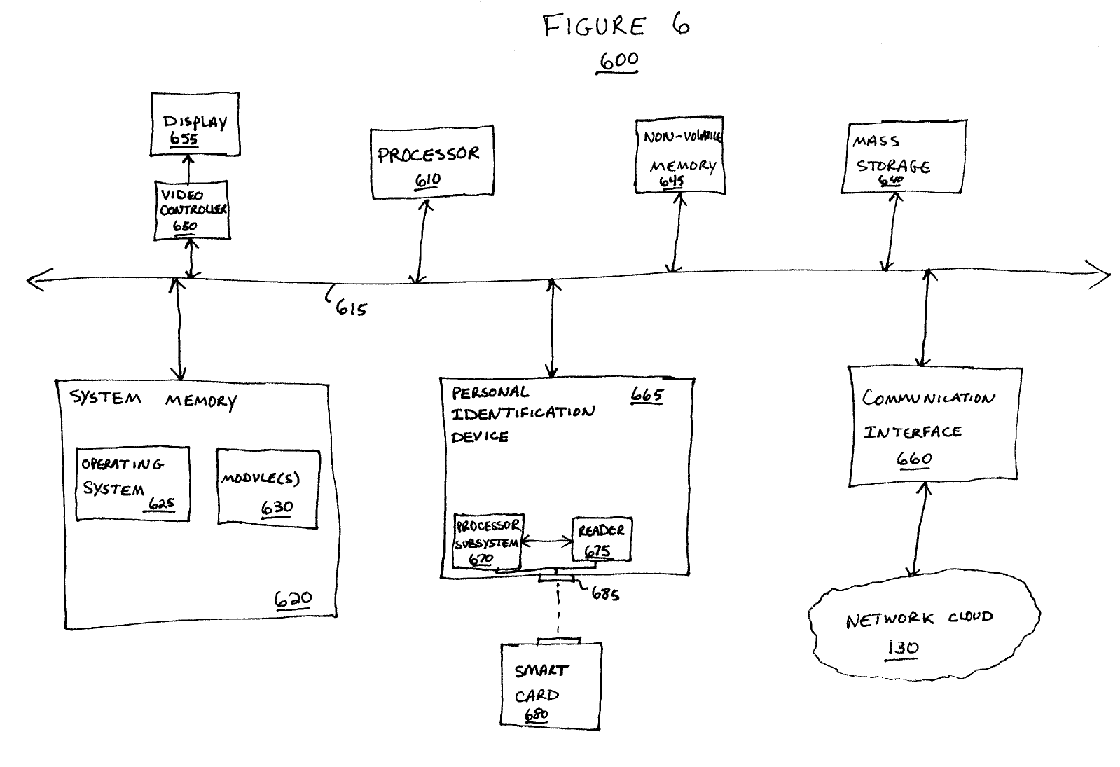

The signature function 230 uses the sender's private signing key 235 to encrypt the message digest 225. As mentioned, the private key 235 may be stored on a “smart” card such as smart card 680 (FIG. 6) where the message digest 225 is uploaded to the “smart” card, and encrypted with the private key to perform the signature function 230. The output of the signature function 230 is a digital signature 240.

Also shown in FIG. 2 is a signed web page object 245 which is a software program, module, subroutine, or code which is optionally downloaded with the web page 210. The object 245 may be an ActiveX Control, Java Script, “plug-in,” etc. The object 245 is used on the recipient computer system (e.g., as a “plug-in” or self-contained program) for validating and authenticating the signed web page. Note that the object 245 may be compatible across all platforms. Once the object 245 is downloaded, it need not be downloaded again.

The web page 210, digital signature 240, digital certificate 250, and object 245 may be packed, appended, and/or concatenated and are then downloaded to one or more recipients such as user computer system 140 via the Internet, a direct connection, a floppy disk that is handed or delivered to the recipient(s), etc.

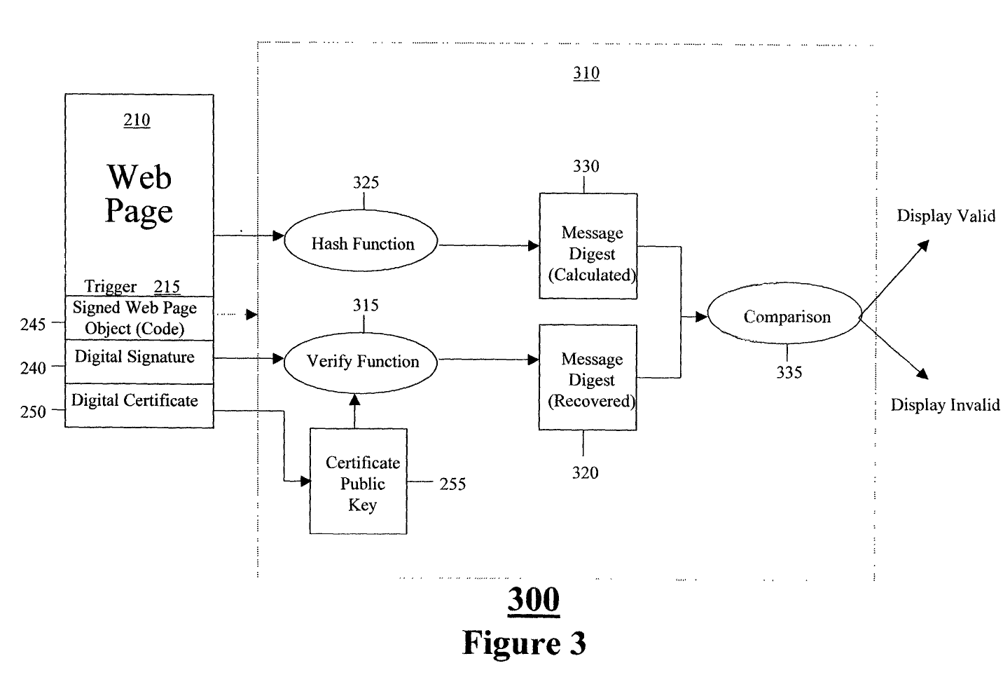

FIG. 3 illustrates an exemplary process 300 on a recipient computer system for verifying and authenticating a web page, according to one embodiment of the present invention. The recipient computer system such as user computer system 140 receives (e.g., over the Internet) and/or loads (e.g., from a floppy or hard disk) the web page 210, digital signature 240, digital certificate 245, and/or object 245.

The software (e.g., Internet Explorer™) on the user computer system 140, while interpreting the web page 210, recognizes the trigger 215 in the web page 210 and invokes the object 245, which may already be loaded on the user computer system 140 (e.g., as a “plug-in”), or may be included with the web page 210. Alternatively, if the object 245 is neither installed on the user computer system 140 nor included with the web page 210, the trigger may cause retrieval of the object 245 from the server computer system 110 or other dedicated location. Once invoked, the object 245 executes a validation and/or authentication process, an embodiment of which is shown by numeral 310.

The digital signature 240 is applied to a verify function 315. Using the retrieved public key 255, the digital signature 240 is decrypted, providing the recovered message digest 320. The web page 210 is also applied to a hash function 325 which operates on the web page 210, using the same hash algorithm as used on the server computer system 110, to yield a (calculated) message digest 330. The type and version of the hash function used is typically included in the digital certificate 250.

The (calculated) message digest 330 is then compared with the (recovered) message digest 320, as shown by numeral 335, to determine the integrity of the web page. If the two are unequal, then the digital signature is not valid, and authentication cannot be confirmed. In this case, a message may be displayed on the display screen indicating that the web page is not to be trusted, and viewing of the web page may be disallowed. If message digests 320 and 330 are equal, then a valid message or valid icon may be displayed on the display screen (e.g., a valid icon or button on the browser) indicating that the web page has been validated and authenticated. The user may also send an optional request to the optional database 160 (FIG. 1) to check the validity of the server's digital certificate. It is to be noted that the process 310 may not be invoked if the web page 210 does not contain the trigger 215. With this mechanism, validity can be attached to web pages and the source of the web pages can be authenticated.

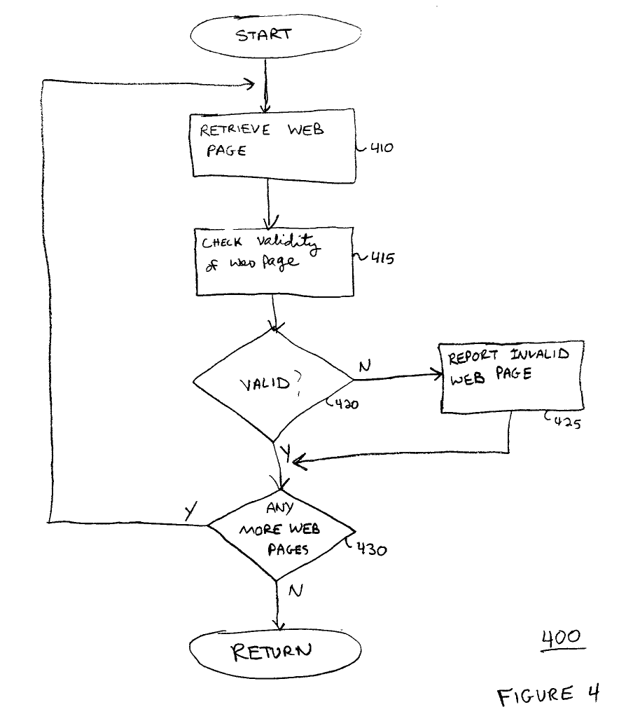

Referring to FIGS. 1 and 3, as part of the maintenance of web pages 115₁-115_{A} on the server computer system 110, the validity of the signed web pages can be periodically checked. FIG. 4 shows an exemplary process 400 for periodically checking the validity of web pages 115₁-115_{A}, and reporting any invalid pages, according to one embodiment of the present invention. The process 400 may be a software program located and executed on the server computer system 110 (FIG. 1) or may be on a different computer system. The process 400 commences at block 410 where a web page, digital signature, and an optional digital certificate are retrieved. At blocks 415 and 420, the validity of the web page is determined, similar to the process 310 in FIG. 3. If the web page is valid (the calculated message digest is equal to the recovered message digest), the process moves to block 430. If the web page is not valid (the calculated message digest is not equal to the recovered message digest), the process moves to block 425 where the invalid web page is reported. Reporting may involve recording all invalid web pages in a table, and notifying the operator/owner of the server computer system 110 of the invalid pages. Appropriate corrective action may then be taken to remedy any security and other issues. At block 430, the process determines if there are any more web pages. If not, the process ends. If so, blocks 410 to 430 are executed for all remaining web pages. The process 400 may be invoked upon request by the server computer system 110 on a regular basis such as daily or a shorter or longer granularity depending on the sensitivity of the content, the dynamic nature of the content, and/or other factors.

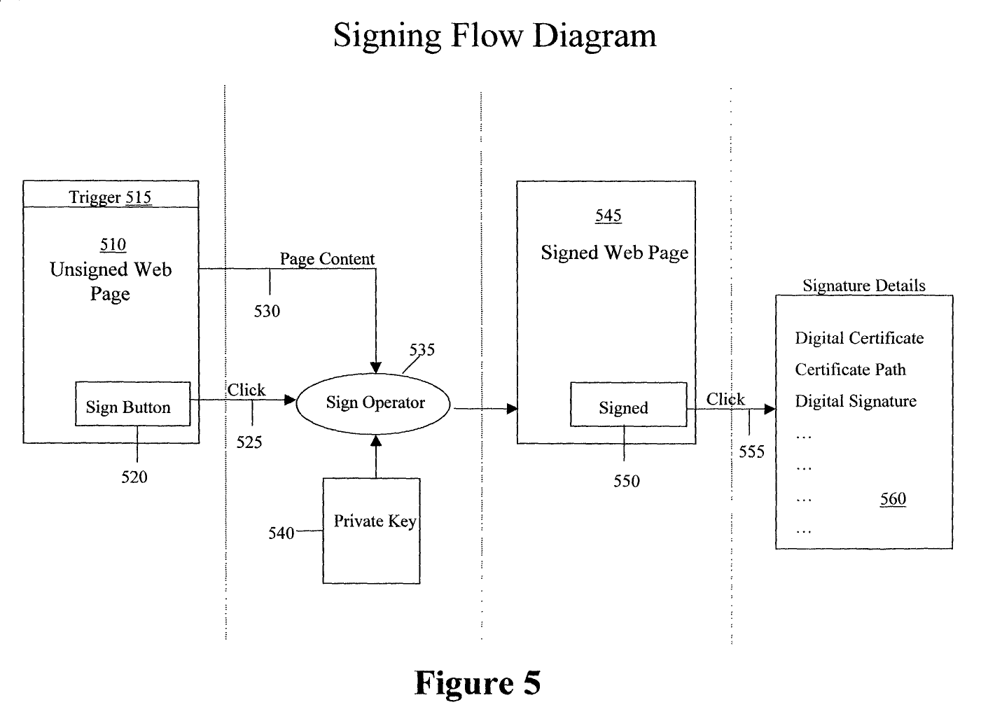

FIG. 5 shows an exemplary signing and validating process 500, according to another embodiment of the present invention. In this exemplary embodiment, a server, such as server 110 transmits an unsigned web page or file to a client, such as user computer system 140, requesting the client to digitally sign the web page or file and transmit the same back to the server. For example, the server may transmit a web page containing a form and a purchase request to the client. The web page may include information such as the items selected for purchase, price, client information, if available, etc. The client may digitally sign the web page and transmit it back to the server. This mechanism may be used for various purposes such as requesting a client to digitally sign a contract, non-disclosure agreement, and other documents where identity, authority, and/or authentication may be required.

Referring to FIGS. 1 and 5, the server computer system 110 downloads to the user computer system 140 an unsigned web page 510. A trigger 515 is embedded in, attached to, etc. to the web page 510, or its header. The trigger 515 invokes the object on the client computer system. The object detects that the web page 510 is not digitally signed, since a digital signature did not accompany the web page 510. This may signal to the user that the server is requesting the user to digitally sign the web page. Consequently, the browser or other software may display a message on the display screen requesting the user to digitally sign the web page 510.

The web page 510 may also optionally include a sign button 520. A user may “click” or otherwise select the sign button 520, as shown by arrow 525, to commence the signing process, either in response to the request or independently. The web page 510 is applied to a sign operator 535 together with the user's private singing key 540. The sign operator 535 typically applies the web page 510 to a hash function to generate a message digest, and signs the message digest with the private signing key 540. The output of the sign operator is a signed web page 545. The signed web page 545 may include a signed button 550, which when “clicked” or otherwise selected, as shown by arrow 555, shows the signature details 560 such as the digital certificate, certificate path, and digital signature. The signed web page 545 may then be transmitted back to the server.

FIG. 6 illustrates a block diagram of a computer system 600, according to one embodiment of the present invention. For sake of clarity, the computer system 600 may be representative of the server computer system 110, user computer system 140, or any other computer system.

Referring to FIG. 6, the computer system 600 includes a processor 610 that is coupled to a bus structure 615. The processor 610 may include a microprocessor such as a Pentium™ microprocessor, microcontroller, or any other of one or more devices that process data. Alternatively, the computer system 600 may include more than one processor. The bus structure 615 includes one or more buses and/or bus bridges that couple together the devices in the computer system 600.

The processor 610 is coupled to a system memory 620 such as a random access memory (RAM), non-volatile memory 645 such as an electrically erasable programmable read only memory (EEPROM) and/or flash memory, and mass storage device 640. The non-volatile memory 645 includes system firmware such as system BIOS for controlling, among other things, hardware devices in the computer system 600.

The computer system 600 includes an operating system 625, and one or more modules 630 that may be loaded into system memory 620 from mass storage 640 at system startup and/or upon being launched. The operating system 625 includes a set of one or more programs that control the computer system's operation and allocation of resources. In one embodiment, the operating system 625 includes, but not limited or restricted to, disc operating system (DOS), Windows™, UNIX™, and Linux™. In one embodiment, one or more modules 630 are application programs, drivers, subroutines, and combinations thereof. One or more module(s) and/or application program(s) or portions thereof may be loaded and/or stored in the processor subsystem 670 and/or the “smart” card 680 (e.g., in non-volatile memory). One or more of the modules and/or application programs may be obtained via the Internet or other network.

On a certification authority computer system 150, the one or more application programs and/or modules are used to create digital certificates, and transmit the certificates to the subscriber's computer system. On the server computer system 110, one or more application programs and/or modules may be used to digitally sign web pages using a digital certificate. On the user computer system 140, one or more application programs and/or modules may be used to validate and authenticate signed web pages.

The mass storage device 640 includes (but is not limited to) a hard disk, floppy disk, CD-ROM, DVD-ROM, tape, high density floppy, high capacity removable media, low capacity removable media, solid state memory device, etc., and combinations thereof. In one embodiment, the mass storage 640 is used to store documents, where digitally signed or not, a viewer program/module, etc. The mass storage may also store the operating system and/or modules that are loaded into system memory 620 at system startup.

The computer system 600 also includes a video controller 650 for driving a display device 655, and a communication interface 660 such as a T1 connection for communicating over the network cloud 130 (FIG. 1).

Also coupled to the bus structure 615 is an optional personal identification device 665 that includes a processor subsystem 670 and a card reader/writer 675, which may optionally include a keypad. The processor subsystem 670 includes a microprocessor or microcontroller, memory, and software running thereon for communicating with the card reader/writer 675 and other module(s) and/or devices in the computer system 600. In one embodiment, a user's private signing key and other information such as the user's personal information and PIN may be stored on a “smart” card 680, which includes a processor, memory, communication interface (e.g., serial interface), etc. Optionally, the personal identification device 665 or the card reader/writer 675 may include or may be coupled to one or more biometrics devices to scan in the user's thumb print, perform a retinal scan, and read other biometrics information. In such a case, the “smart” card 680 may include a digital representation of the user's thumb print, retinal scan, and the like.

When digitally signing web pages and other objects, the user connects the “smart” card 680 to the card reader/writer 675 or some other location on the personal identification device 665 (e.g., via a port 685). Optionally, the keypad on the card reader/writer 675 may include a display that prompts the user to “Enter in a PIN” and/or “Provide biometrics authentication” (e.g., a thumb print). The PIN provided by the user is then uploaded to the “smart” card 680 via the port 685. The “smart” card 680 then compares the PIN entered on the keypad and the PIN stored on the “smart” card. The “smart” card may also compare biometrics information (e.g., a user's thumb print) stored thereon with biometrics information scanned or otherwise obtained from the user. If there is a mismatch, the user may be prompted with a message such as “Incorrect PIN. Please Enter correct PIN”. If they match, the “smart” card then requests the message digest from the computer system for encrypting the message digest with the user's private signing key. The message digest may be stored in system memory 620, mass storage 640, and/or other location. The message digest may be retrieved through the processor subsystem 670 or directly from the processor 610. In either case, the “smart” card reads the message digest, and encrypts the same with the user's private signing key to provide a digital signature. The memory on the “smart” card 680 includes encryption algorithm and software for generating the digital signature based on the private key.

In another embodiment, the comparison of the PIN stored on the “smart” card 680 and the PIN entered by the user on the keypad, and the encryption of the message digest with the user's private signing key may be performed by the processor subsystem 670. In such a case, the “smart” card downloads the PIN and the private key stored thereon to the processor subsystem 670.

Embodiments of the present invention may be implemented as a method, apparatus, system, etc. When implemented in software, the elements of the present invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method, comprising:
digitally signing a web page that includes a trigger with a private key to provide a digital signature;
transmitting the web page, the digital signature, and a digital certificate from a first computer system to a second computer system; and
responsive to the trigger, automatically verifying the digital signature on the second computer system using a public key corresponding to the private key.

2. The method of claim 1 wherein transmitting comprises transmitting the web page, the digital signature, and the digital certificate including the public key corresponding to the private key from the first computer system to the second computer system.

3. The method of claim 1 wherein transmitting comprises transmitting the web page, the digital signature, the digital certificate, and an object from the first computer system to the second computer system.

4. The method of claim 3 wherein automatically verifying comprises responsive to the trigger, automatically verifying the digital signature on the second computer system using the object.

5. The method of claim 1 wherein digitally signing comprises:
hashing the web page to provide a message digest; and
digitally signing the message digest with a private key to provide the digital signature.

6. The method of claim 1 wherein the trigger includes one or more of the following: a flag, variable, one or more lines of code, and subroutine.

7. The method of claim 1 further comprising one of the following:
embedding the trigger in the web page;
incorporating the trigger in the web page;
appending the trigger to the web page; and
placing the trigger in a HTTP header of the web page.

8. A computer system, comprising:
a memory including one or more instructions; and
a processor coupled to the memory, the processor, responsive to the one or more instructions, to,
transmit a request for a web page over a communication link,
receive the web page including a trigger, a digital signature, and a digital certificate, and
responsive to the trigger, automatically verify the digital signature of the web page using a public key corresponding to a private key used to digitally sign the web page.

9. The apparatus of claim 8 wherein the processor, in response to the one or more instructions, to receive the web page, digital signature, and the digital certificate including the public key.

10. The apparatus of claim 8 wherein the processor, in response to the one or more instructions, to receive the web page, digital signature, digital certificate, and an object, said object being executed by the processor to automatically verify the digital signature of the web page.

11. The apparatus of claim 8 wherein the processor automatically verifies the digital signature of the web page by
hashing the web page to provide a calculated message digest;
decrypting the digital signature using the public key to provide a recovered message digest; and
comparing the calculated message digest and the recovered message digest.

12. The apparatus of claim 8 wherein the trigger includes one or more of the following: a flag, variable, one or more lines of code, and subroutine.

13. The apparatus of claim 8 wherein the memory includes a software routine for plug-in comprising the one or more instructions.

14. The apparatus of claim 8 wherein the memory includes one of a browser software program and a plug-in comprising the one or more instructions.

15. A method, comprising:
receiving a request for a web page;
digitally signing the web page that includes a trigger with a private key to provide a digital signature, said trigger for causing a program on a computer system to automatically verify the digital signature of the web page; and
transmitting the web page, the digital signature, and a digital certificate to the computer system in response to receiving the request for the web page.

16. The method of claim 15 wherein transmitting comprises transmitting the web page, the digital signature, and the digital certificate including a public key corresponding to the private key to the computer system, in response to receiving the request for the web page.

17. The method of claim 15 wherein transmitting comprises transmitting the web page, the digital signature, the digital certificate, and an object to the computer system, in response to receiving the request for the web page.

18. The method of claim 17 wherein said object, on the computer system, for detecting the trigger, and in response to detecting the trigger, automatically verifying the digital signature of the web page.

19. The method of claim 15 wherein the trigger includes one or more of the following: a flag, variable, one or more lines of code, and subroutine.

20. The method of claim 15 further comprising one of the following:
embedding the trigger in the web page;
incorporating the trigger in the web page;
appending the trigger to the web page; and
placing the trigger in a HTTP header of the web page.

21. A method, comprising:
transmitting a web page that includes a trigger from a first computer system to a second computer system;
displaying the web page on a display of the second computer system;
detecting the trigger by a program executed on a processor of the second computer system;
automatically requesting that the web page be digitally signed;
digitally signing the web page with a private key to provide a digital signature; and
transmitting the web page, digital signature, and a digital certificate to the first computer system.

22. The method of claim 21 wherein the trigger includes one or more of the following: a flag, variable, one or more lines of code, and subroutine.

23. The method of claim 21 further comprising one of the following:
embedding the trigger in the web page;
incorporating the trigger in the web page;
appending the trigger to the web page; and
placing the trigger in a HTTP header of the web page.

24. The method of claim 21 wherein the program is one or more of the following: a plug in and browser program.
